(19) United States
(12) Patent Application Publication
(10) Pub. No.: US 2010/0173668 A1
(43) Pub. Date: Jul. 8, 2010

(54) METHOD AND APPARATUS FOR IMPLEMENTING MULTIPLE DIAL PADS ON A PORTABLE ELECTRONIC DEVICE

(76) Inventors: Keizo Marui, Waterloo (CA); Larry Kuhl, Waterloo (CA); Brian Groux, Waterloo (CA)

Correspondence Address: Ridout & Maybee LLP, 225 King Street West, 10th Floor, Toronto, ON, M5V 3M2, CA

(21) Appl. No.: 12/350,752

(22) Filed: Jan. 8, 2009

(51) Int. Cl. H04B 1/38; G06F 3/045; H04M 1/00

(52) U.S. Cl. 455/556.1; 455/566; 345/174; 345/169

(57) ABSTRACT

A portable electronic device that allows a user to dial a telephone number using a first dial pad configuration selected from more than one dial pad configuration stored in a memory of the portable electronic device. The device may include a touch screen display, and the first dial pad configurations can include a rotary dial configuration and a writing zone configuration. The portable electronic device may also include an accelerometer, in which case the first dial pad configuration may also include a configuration that requires a user to wave the portable electronic device in the air as if to write a digit.

### RESERVATION OF COPYRIGHT

A portion of the disclosure of this patent document contains material which is subject to copyright protection. The copyright owner has no objection to the facsimile reproduction by any one of the patent document or patent disclosure, as it appears in the Patent and Trademark Office patent file or records, but otherwise reserves all copyrights whatsoever.

### FIELD OF THE INVENTION

Embodiments relate generally to the implementation of multiple dial pads on a portable electronic device and related methods and apparatuses disclosed herein.

### BACKGROUND OF THE INVENTION

Portable electronic devices such as mobile telephones or personal digital assistants (PDAs) generally include a keypad for user input. Traditionally, the keypad is a set of physical keys or buttons that a user may push in order to make user selections. For instance, a cellular telephone may include a grid of physical keys or buttons that may be pushed in order to dial a phone number. However, in more recent portable electronic devices, the keypad is implemented as a virtual keypad displayed on a touch screen. The touch screen of the portable electronic device displays regions that may be touched by a user. The regions may be associated with digits 0-9, although other associations are possible (e.g., *, #, etc.). Selection of a region by a user results in the dialing of the corresponding digit in a phone number. The regions act as buttons or keys and generate a signal when touched. The signals generated are interpreted by the portable electronic device and result in the dialing of a phone number defined by the numbers associated with the touched regions.

Generally, a touch screen of a portable electronic device displays the virtual push button dial pad when the device is in a phone number dialing mode. In this mode, not only does the device display a dialing key pad, but the device also interprets user input through the dialing keypad in order to assemble and dial phone numbers. When the device is not in a phone number dialing mode, the virtual dial pad is not displayed and user input does not automatically result in the dialing of a phone number.

In many cases, the virtual dial pad displayed on a portable electronic device touch screen is similar in orientation and function to a standard touch tone telephone dialing pad. That is, the numbered buttons are arranged in four rows of keys, three columns wide. Numbers 0-9 are represented on the virtual “keys.” A “star” (“*”) key and a “pound” (“#”) key are usually also displayed. Other alpha-numeric symbols may also be associated with the virtual keys. Using this standard orientation, a user may dial a phone number by pushing the appropriate virtual keys. Thus, a user may dial a phone number using a touch screen of the portable electronic device in a way that is similar to most other touch tone dial pads function.

### BRIEF DESCRIPTION OF THE DRAWINGS

FIG. 1 illustrates a portable electronic device for communicating with a network in accordance with an embodiment disclosed herein.

FIG. 2 illustrates the internal components of the portable electronic device in accordance with an embodiment disclosed herein.

FIG. 3 illustrates a conventional dial pad configuration on a portable electronic device.

FIGS. 4A and 4B illustrate dial pad configurations in accordance with an embodiment disclosed herein.

FIG. 5 illustrates a dial pad configuration in accordance with an embodiment disclosed herein.

FIG. 6 illustrates a dialing configuration in accordance with an embodiment disclosed herein.

### DETAILED DESCRIPTION OF THE INVENTION

Example embodiments and applications will now be described. It should be appreciated that other embodiments may be realized and structural or logical changes may be made to the disclosed embodiments.

An advantage of using a touch screen to display a virtual dial pad is that the dial pad need not be limited to a specific orientation such as the standard dial pad orientation. Because there is a desire, and even a need, for additional virtual dial pads to be used on a portable electronic device with a touch screen, embodiments of multiple virtual dial pads integrated into the portable electronic device are disclosed below.

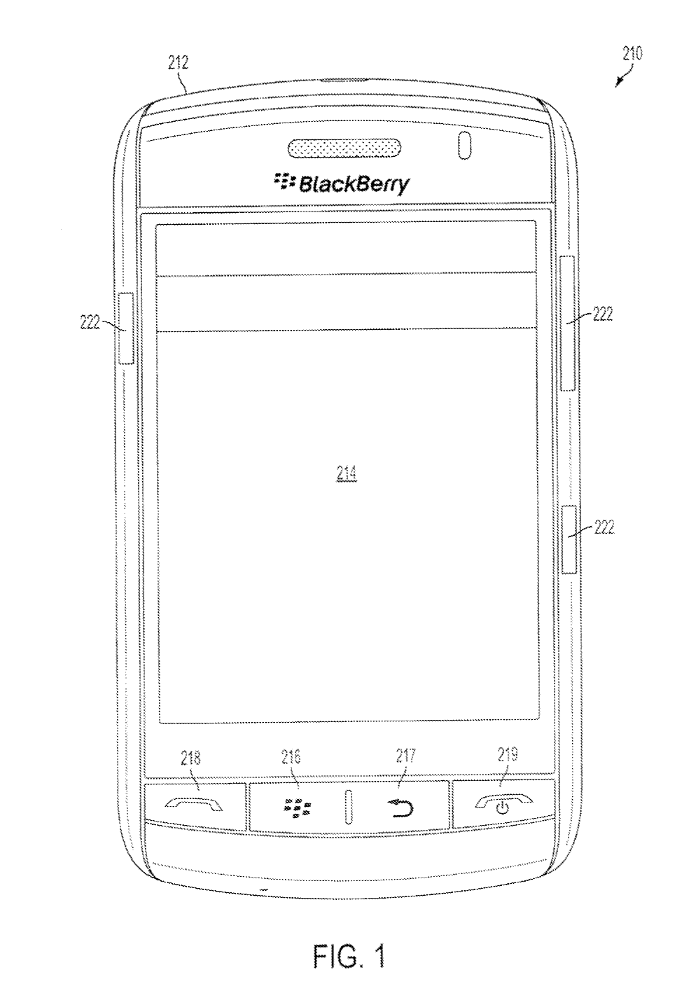

FIG. 1 illustrates a portable electronic device 210 according to a disclosed embodiment. The portable electronic device 210 is a dual mode (simultaneous data and voice communication capabilities) device, personal digital assistant, etc. Such devices include BlackBerry™ devices by Research in Motion Limited of Ontario, Canada, or Palm® Treo™ devices by Palm, Inc. of California, U.S.A. to name a few. In addition, the portable electronic device 210 may be a cellular telephone. The device 210 includes a portable housing 212 and a touch screen display 214 such as a capacitive or resistive touch screen display. The device 210 may also include a physical keyboard, though, as explained below, a physical keyboard can be replaced by a virtual keyboard on the touch screen display 214. The device 210 may include additional physical buttons such as a menu button 216, a go back button 217, a dial button 218 and an end call button 219. The menu button 216, when pushed, results in the display of a menu on the touch screen display 214. The go back button 217 allows a user to go back to a previously viewed image or page on the display 214. The dial button 218 and end call button 219, as explained in more detail below, are used to begin and end phone calls. The device 210 also includes a plurality of additional physical buttons 222 that may be used to activate certain default applications or features of the device 210 when pushed, or which may be customizable to perform desired functions when pushed. The touch screen display 214 displays menus and applications that may be selected by a user through touching the appropriate region of the touch screen display 214.

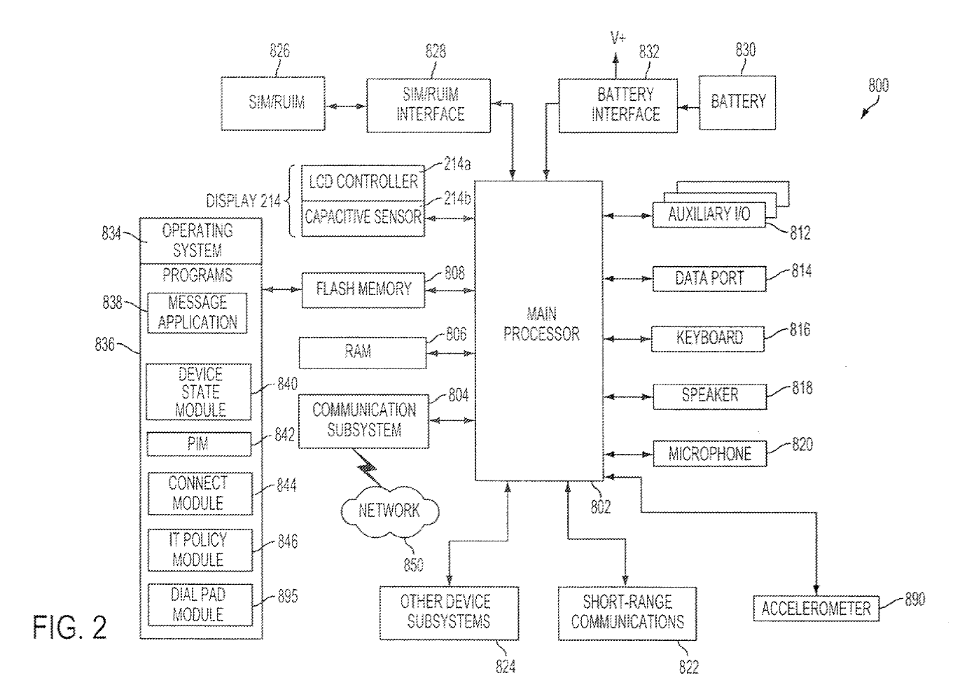

The device 210 also includes internal components that may be implemented through a combination of both hardware and software. Internal components 800 of the device 210 are illustrated in FIG. 2. The portable electronic device 210 includes a number of components such as a main processor 802 that controls the overall operation of the portable electronic device 210. Communication functions, including data and voice communications, are performed through a communication subsystem 804. The communication subsystem 804 receives messages from and sends messages to a wireless network 850. In this example embodiment of the portable electronic device 210, the communication subsystem 804 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behavior described herein, and it will also be understood by persons skilled in the art that the embodiments described herein are intended to use any other suitable standards that are developed in the future. The wireless link connecting the communication subsystem 804 with the wireless network 850 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 850 associated with portable electronic device 210 is a GSM/GPRS wireless network in one example implementation, other wireless networks may also be associated with the portable electronic device 210 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and third-generation (3G) networks like EDGE and UMTS. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 802 also interacts with additional subsystems such as a random access memory (RAM) 806, a flash memory 808, the touch screen display 214, an auxiliary input/output (I/O) subsystem 812, a data port 814, a speaker 818, a microphone 820, short-range communications 822, an accelerometer 890 and other device subsystems 824 (including, but not limited to a camera).

Some of the subsystems of the portable electronic device 210 perform communication-related functions, whereas other subsystems may provide “resident” or on-device functions. By way of example, the touch screen display 214 may be used for both communication-related functions, such as entering a text message for transmission over the network 850, and device-resident functions such as a calculator or task list.

The portable electronic device 210 can send and receive communication signals over the wireless network 850 after required network registration or activation procedures have been completed. Network access is associated with a subscriber or user of the portable electronic device 210. To identify a subscriber, the portable electronic device 210 requires a SIM/RUIM card 826 (i.e., Subscriber Identity Module or a Removable User Identity Module) to be inserted into a SIM/RUIM interface 828 in order to communicate with a network. The SIM card or RUIM 826 is one type of a conventional “smart card” that can be used to identify a subscriber of the portable electronic device 210 and to personalize the portable electronic device 210, among other things. Without the SIM card 826, the portable electronic device 210 is not fully operational for communication with the wireless network 850. By inserting the SIM card/RUIM 826 into the SIM/RUIM interface 828, a subscriber can access all subscribed services. Services may include: web browsing and messaging such as e-mail, voicemail, Short Message Service (SMS), and Multimedia Messaging Services (MMS). More advanced services may include: point of sale, field service and sales force automation. The SIM card/RUIM 826 includes a processor and memory for storing information. Once the SIM card/RUIM 826 is inserted into the SIM/RUIM interface 828, it is coupled to the main processor 802. In order to identify the subscriber, the SIM card/RUIM 826 can include some user parameters such as an International Mobile Subscriber Identity (IMSI). An advantage of using the SIM card/RUIM 826 is that a subscriber is not necessarily bound by any single physical mobile device. The SIM card/RUIM 826 may store additional subscriber information for a mobile device as well, including datebook (or calendar) information and recent call information. Alternatively, user identification information can also be programmed into the flash memory 808.

According to a preferred embodiment, the portable electronic device 210 is a battery-powered device and includes a battery interface 832 for receiving one or more rechargeable batteries 830. In at least some embodiments, the battery 830 can be a smart battery with an embedded microprocessor. The battery interface 832 is coupled to a regulator (not shown), which assists the battery 830 in providing power V+ to the portable electronic device 210. Although current technology makes use of a battery, future technologies such as micro fuel cells may provide the power to the portable electronic device 210.

The portable electronic device 210 also includes an operating system 834 and software components 836 to 846, 895 which are described in more detail below. The operating system 834 and the software components 836 to 846, 895 that are executed by the main processor 802 are typically stored in a persistent storage such as the flash memory 808, which may alternatively be a read-only memory (ROM) or similar storage element (not shown). Those skilled in the art will appreciate that portions of the operating system 834 and the software components 836 to 846, 895 such as specific device applications, or parts thereof, may be temporarily loaded into a volatile store such as the RAM 806. Other software components can also be included, as is well known to those skilled in the art.

The subset of software applications 836 that control basic device operations, including data and voice communication applications, will normally be installed on the portable electronic device 210 during its manufacture. Other software applications include a message application 838 that can be any suitable software program that allows a user of the portable electronic device 210 to send and receive electronic messages. Various alternatives exist for the message application 838 as is well known to those skilled in the art. Messages that have been sent or received by the user are typically stored in the flash memory 808 of the portable electronic device 210 or some other suitable storage element in the portable electronic device 210. In at least some embodiments, some of the sent and received messages may be stored remotely from the portable electronic device 210 such as in a data store of an associated host system that the portable electronic device 210 communicates with.

The software applications can further include a device state module 840, a Personal Information Manager (PIM) 842, and other suitable modules (not shown). The device state module 840 provides persistence, i.e., the device state module 840 ensures that important device data is stored in persistent memory, such as the flash memory 808, so that the data is not lost when the portable electronic device 210 is turned off or loses power.

The PIM 842 includes functionality for organizing and managing data items of interest to the user, such as, but not limited to, e-mail, contacts, calendar events, voicemails, appointments, and task items. A PIM application has the ability to send and receive data items via the wireless network 850. PIM data items may be seamlessly integrated, synchronized, and updated via the wireless network 850 with the mobile device subscriber's corresponding data items stored and/or associated with a host computer system. This functionality creates a mirrored host computer on the portable electronic device 210 with respect to such items. This can be particularly advantageous when the host computer system is the mobile device subscriber's office computer system.

The portable electronic device 210 also includes a connect module 844, and an IT policy module 846. The connect module 844 implements the communication protocols that are required for the portable electronic device 210 to communicate with the wireless infrastructure and any host system, such as an enterprise system, that the portable electronic device 210 is authorized to interface with.

The connect module 844 includes a set of APIs that can be integrated with the portable electronic device 210 to allow the portable electronic device 210 to use any number of services associated with the enterprise system. The connect module 844 allows the portable electronic device 210 to establish an end-to-end secure, authenticated communication pipe with the host system. A subset of applications for which access is provided by the connect module 844 can be used to pass IT policy commands from the host system to the portable electronic device 210. This can be done in a wireless or wired manner. These instructions can then be passed to the IT policy module 846 to modify the configuration of the portable electronic device 210. Alternatively, in some cases, the IT policy update can also be done over a wired connection.

The IT policy module 846 receives IT policy data that encodes the IT policy. The IT policy module 846 then ensures that the IT policy data is authenticated by the portable electronic device 210. The IT policy data can then be stored in the flash memory 806 in its native form. After the IT policy data is stored, a global notification can be sent by the IT policy module 846 to all of the applications residing on the portable electronic device 210. Applications for which the IT policy may be applicable then respond by reading the IT policy data to look for IT policy rules that are applicable.

The IT policy module 846 can include a parser (not shown), which can be used by the applications to read the IT policy rules. In some cases, another module or application can provide the parser. Grouped IT policy rules, described in more detail below, are retrieved as byte streams, which are then sent (recursively, in a sense) into the parser to determine the values of each IT policy rule defined within the grouped IT policy rule. In at least some embodiments, the IT policy module 846 can determine which applications are affected by the IT policy data and send a notification to only those applications. In either of these cases, for applications that aren't running at the time of the notification, the applications can call the parser or the IT policy module 846 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 846 sends an acknowledgement back to the host system to indicate that the IT policy data was received and successfully applied.

The dial pad module 895 may be a part of the connect module 844 or may be a separate module, as illustrated in FIG. 2. In either scenario, the dial pad module 895 is used by the connect module 844 when a user of the portable electronic device desires to dial and connect to a telephone number. The dial pad module 895 includes instructions to implement one or more telephone number dialing methods. Examples of dialing methods that may be implemented are described below.

Other types of software applications can also be installed on the portable electronic device 210. These software applications can be third party applications, which are added after the manufacture of the portable electronic device 210. Examples of third party applications include games, calculators, utilities, etc, as well as third party APIs. Other examples of third party applications include updates to the dial pad module 895. The updates to the dial pad module 895 may include embedded software applications that provide replacement dialing instructions for the dial pad module 895.

The additional applications can be loaded onto the portable electronic device 210 through at least one of the wireless network 850, the auxiliary I/O subsystem 812, the data port 814, the short-range communications subsystem 822, or any other suitable device subsystem 824. This flexibility in application installation increases the functionality of the portable electronic device 210 and may provide enhanced on-device functions, communication-related functions, or both. For example, secure communication applications may enable electronic commerce functions and other such financial transactions to be performed using the portable electronic device 210.

The data port 814 enables a subscriber to set preferences through an external device or software application and extends the capabilities of the portable electronic device 210 by providing for information or software downloads to the portable electronic device 210 other than through a wireless communication network. The alternate download path may, for example, be used to load an encryption key onto the portable electronic device 210 through a direct and thus reliable and trusted connection to provide secure device communication.

The data port 814 can be any suitable port that enables data communication between the portable electronic device 210 and another computing device. The data port 814 can be a serial or a parallel port. In some instances, the data port 814 can be a USB port that includes data lines for data transfer and a supply line that can provide a charging current to charge the battery 830 of the portable electronic device 210.

The short-range communications subsystem 822 provides for communication between the portable electronic device 210 and different systems or devices, without the use of the wireless network 850. For example, the subsystem 822 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 804 and input to the main processor 802. The main processor 802 will then process the received signal for output to the display 214. A subscriber may also compose data items, such as e-mail messages, for example, using a virtual keyboard on the display 214 or a physical keyboard 816 in conjunction with the display 214 and possibly the auxiliary I/O subsystem 812. The auxiliary subsystem 812 may include devices such as: a mouse, depressible trackball, infrared fingerprint detector, a depressible thumb navigator or other buttons. A composed item may be transmitted over the wireless network 850 through the communication subsystem 804.

For voice communications, the overall operation of the portable electronic device 210 is substantially similar, except that the received signals are output to the speaker 818, and signals for transmission are generated by the microphone 820. Alternative voice or audio I/O subsystems, such as a voice message recording subsystem, can also be implemented on the portable electronic device 210. Although voice or audio signal output is accomplished primarily through the speaker 818, the display 214 can also be used to provide additional information such as the identity of a calling party, duration of a voice call, or other voice call related information.

An accelerometer 890 is provided for measuring the magnitude and direction of acceleration of the portable electronic device 210. Methods of manufacturing accelerometers are known in the art. One common type of accelerometer 890 is a micro-electrical-mechanical system (MEMS) that includes a cantilever beam and a proof mass. Under the influence of gravity or acceleration, the proof mass deflects from its neutral position. This deflection is measured in an analog or digital manner, which is sent to the main processor 802 as data signals. However, it is appreciated that other types of accelerometers with similar properties may be suitable, as known in the art.

The touch screen display 214 communicates with the main processor 802 via an LCD controller 214a and a sensor 214b. In the illustrated embodiment, the touch screen display 214 is a capacitive touch screen display and the sensor 214b is a capacitive sensor. The LCD controller 214a operates to control the rendering of images, text, data, etc. on the display 214. The capacitive sensor 214b indicates to the main processor 802 if the touch screen display 214 has been touched and where it has been touched in relation to the images and text rendered by the LCD controller 214a.

The process for dialing a phone number using the portable electronic device 210 will now be described. Generally, when a user of the device 210 desires to dial a phone number, the user will first instruct the device 210 to enter a dialing mode, as defined by the dial pad module 895. The dialing mode may be entered by touching an appropriate new item or key on the device 210. The key may be a virtual key on the touch screen display 214, or a physical key such as one of the customizable buttons 222. The dialing mode may also be entered by the user speaking a command such as “Dial” when the device 210 is in a voice activated mode.

Once the dialing mode has been entered, a default dialing pad is displayed on the touch screen display 214. The default dialing pad may be one of any number of dialing pads that are available to the user. The user may change the default dialing pad by navigating the appropriate menus and options displayed on the display 214. However, the selected default dialing pad will always be the dialing pad that is displayed when the dialing mode is entered.

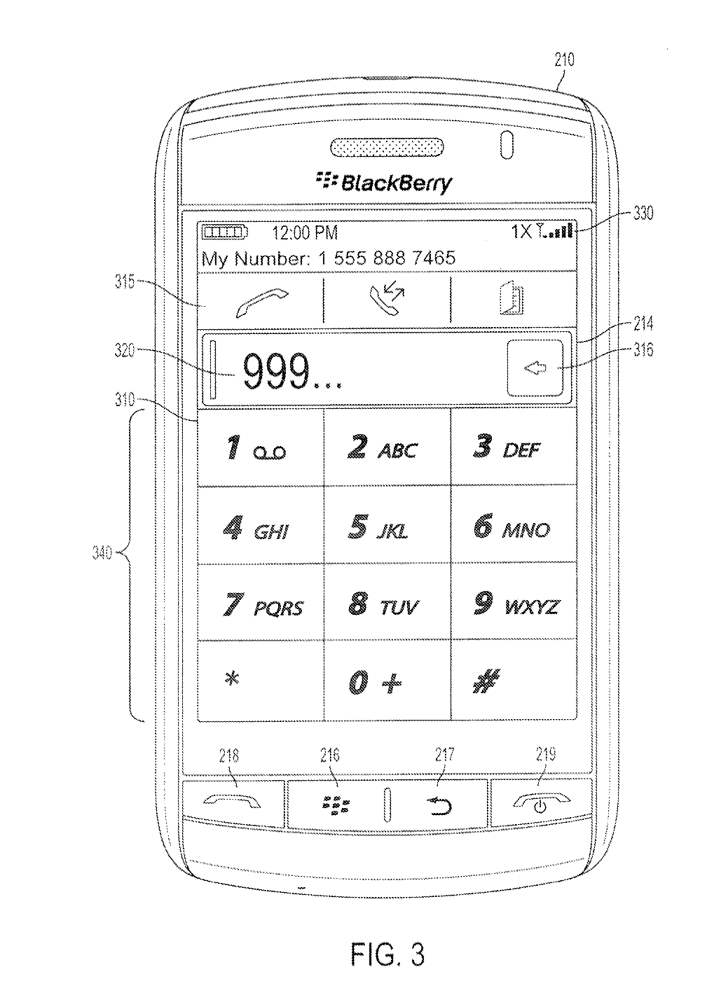

The traditional dialing pad configuration 310 is illustrated in FIG. 3. In FIG. 3, the portable electronic device 210 is displaying a dialing pad configuration 310 within dialpad area 340 on its touch screen display 214. The configuration 310 includes a standard layout of digits in rows and columns of virtual keys. As a user presses the first digit of the desired phone number, the pressed digit appears in input field 320 on the display 214 (in FIG. 3, above the dial pad) as confirmation that the digits have been selected for dialing. Input field 320, located above dialpad 340, contains delete button 316, which can be pressed to delete the last-entered digit. A series of tabs or buttons 315 are positioned above input field 320, and can be configured as user-selectable shortcuts to other telephone related applications, such as the call log or contact list, or as send or end buttons. A banner of status information 330 is optionally displayed above input field 320 and can include information such as a battery life indicator, clock, or signal strength display. Generally, the user first selects all digits in the phone number and then presses a dial or send button 315 (or physical button 218 of FIG. 1). Alternatively, the user may press the dial or send button 315 and then select the digits to be dialed. Once all necessary digits have been selected by the user and the dial or send button 315 has been touched, the device 210 will dial the desired telephone number.

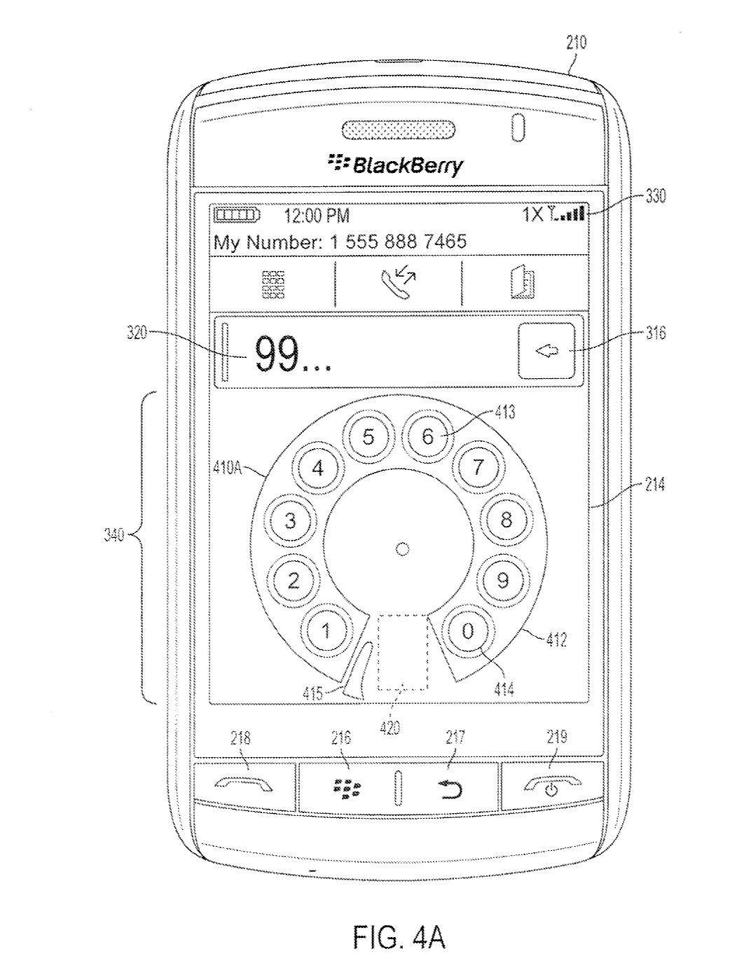

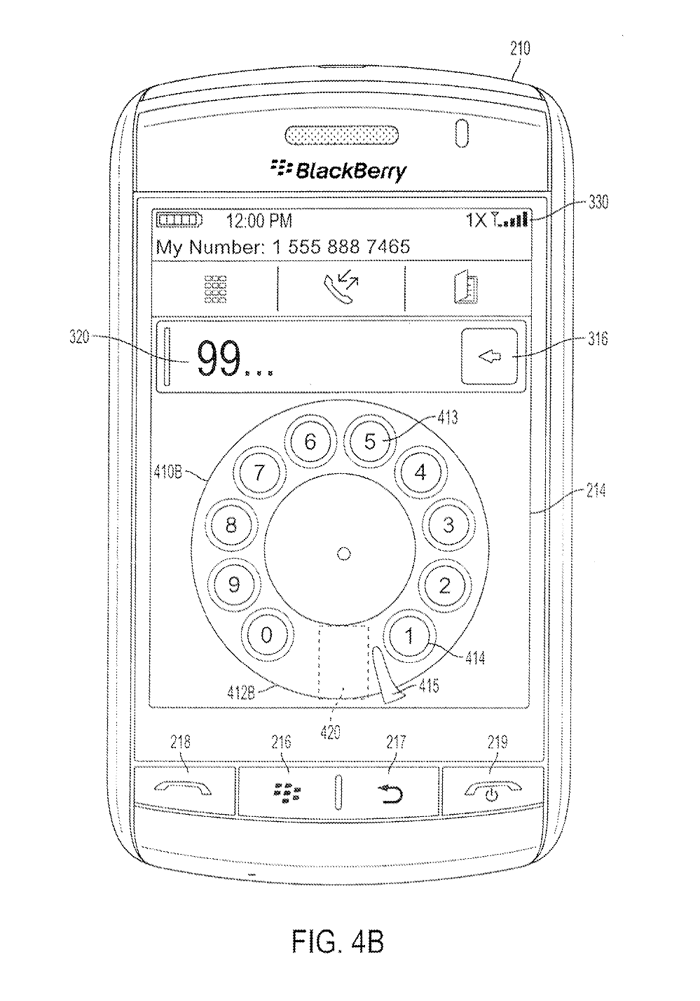

Other dialing pad configurations are also available for display and use in dialpad area 340. FIG. 4A illustrates a virtual rotary dial pad configuration 410A on the device 210. The rotary dial pad is meant to resemble the rotary dial telephones that were prevalent before touch-tone telephones became popular. The configuration 410A includes a horseshoe-like arc 412 over stationary numbers 413 on the display 214. The arc 412 includes finger holes 414, which are initially aligned with the numbers 413. It should be appreciated that the arc 412 could be a circle (e.g., circle 412B illustrated in FIG. 4B), or other desirable shape. To select a number to dial, a user will touch the finger hole 414 over the desired digit and then drag counterclockwise along the arc of numbers until the selected digit has been dragged to a stopping point 415 near the lower left-hand corner of the display 214. As the user drags their finger towards stopping point 415, the finger holes 414 of arc 412 over the numbers will appear to rotate. Alternatively, the digits themselves will rotate so that the dragging of the selected digit results in turning of the arc 412. Once the user has dragged the arc 412 to stopping point 415, the selected dialed digit will appear in input field 320. The selected dialed digit may also appear at another predetermined region 420 on the display 214. The user repeats this dialing process with each desired digit. Once all digits have been dialed the device 210 will dial the telephone number represented by the selected digits.

Of course, the digits displayed in configuration 410A could be rearranged or dialing could be performed in a clockwise manner, as is illustrated in FIG. 4B. The virtual rotary dial pad configuration 410B in FIG. 4B illustrates how the digits may be reversed and dialing may also be reversed. FIG. 4B also illustrates the use of a circle 412B comprising finger holes 414 as described above. Other variations may be made as well.

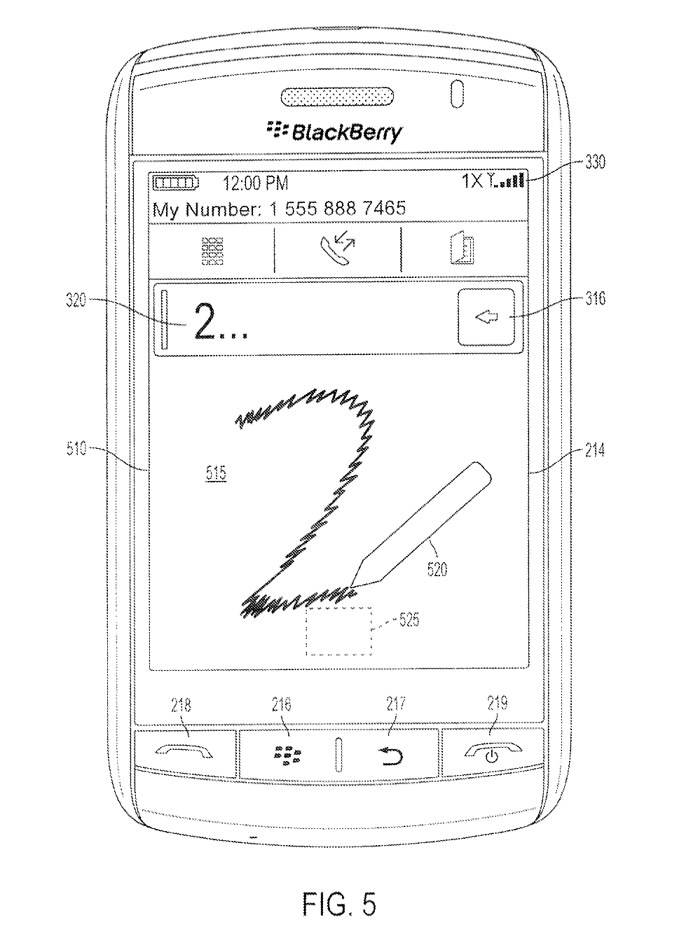

FIG. 5 illustrates an additional virtual dial pad configuration 510. In configuration 510, dialing is effectuated by using a stylus 520 or a finger to “write” the digits to be dialed. Stylus 520 may be used with a resistive touch screen, and a finger with a capacitive touch screen. The touch screen display 214 on the device 210 includes a large writing area 515 in which a user may touch the display 214 and write a digit. In FIG. 5, the user is in the process of writing a “2” with the stylus 520. The dialing pad module 895 includes software that allows the device 210 to recognize letters written by a user. Optionally, dialing pad module 895 can learn how the user “writes” a particular digit. Once the device 210 recognizes the digit (for example, the 2 in FIG. 5) being drawn by the user, the determined digit is displayed in input field 320 on the display 214. Optionally, the recognized digit can be displayed in predetermined area 525. Incorrectly recognized digits can be deleted from input field 320 with delete key 316. In an alternative embodiment, the user can be given an opportunity to confirm that the device 210 has correctly displayed the written digit by waiting for the user to press the displayed digit before moving on to the next desired digit to be written. If the device displays a wrong digit, meaning that the device 210 failed to properly interpret the writing of the user, the user can simply rewrite the digit. Once all digits have been dialed the user can dial the telephone number represented by the selected digits by pressing the physical send button 218 of FIG. 1. Dialing pad module 895 is also adapted to recognize natural language digits, as well as so-called “unistroke” alphanumeric symbols (such as that described in U.S. Pat. No. 5,596,656).

The device 210 may also be programmable to associate different symbols drawn on the display 214 with various digits. As an example, the device 210 may interpret a vertical line made in a downward motion as a “1,” and a vertical line made in an upward motion as a “2.” Other symbols could represent digits 3-0.

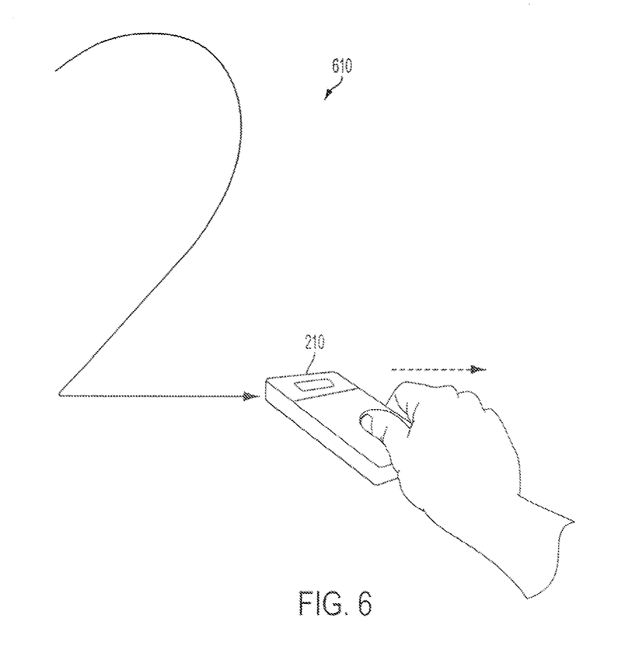

Yet another virtual dial pad configuration 610 is illustrated in FIG. 6. In configuration 610, the user holds the portable electronic device 210 and waves the device in the air as if the user were using the device to write the digits of the telephone number. To “write” a first digit of the number, the user presses a key (either a virtual key on the touch screen display 214 or a customizable physical button 222) on the device 210 to indicate to the device 210 that it should begin recording the physical movement of the device 210. The user continues to press the key until the user has completed “writing” the digit. Physical movement is recorded using the accelerometer 890. In FIG. 6, the user is waving the device 210 so as to write a “2” in the air. The user indicates that he or she has completed writing a digit by releasing the pushed key. The device 210 then displays on the touch screen display 214 the drawn number, as the device 210 interpreted it. In this way, the user can confirm that the device 210 correctly understood the user's actions and, if it did not, the user is able to redraw any incorrect digits. The configuration 610 clearly requires that the dial pad module 895 be in communication with the accelerometer 890. Also, although a touch screen display 214 has been used in the device 210 to aid in the description of configuration 610, a touch screen display is not necessary for the configuration 610 to function properly.

The device 210 may also be programmable to associate different symbols drawn in the air with various digits. As an example, the device 210 may interpret a vertical line made in a downward motion as a “1,” and a vertical line made in an upward motion as a “2.” Other symbols could represent digits 3-0. Alternatively, shaking the device 210 a single time could represent a “1;” shaking the device 210 twice could represent a “2;” and so forth.

Configurations 310, 410, 510, and 610 are each embedded in the dial pad module 895. Additional configurations are possible and may be added by third party applications or APIs.

Although the embodiments and applications as described above relate to a portable electronic device with data and voice communication capacity, it should be understood that they may also be embodied in and applied with any portable electronic device with an ability to dial telephone numbers.

Specific embodiments and applications related to the above description include, but are not limited to, a portable electronic device that includes a display, a communication system, and a first dial pad configuration selected from more than one dial pad configuration stored in a memory of the portable electronic device. The first dial pad configuration enables a user of the portable electronic device to dial and call a telephone number using the display and the communication system. The display can be a capacitive touch screen display, and the first dial pad configurations can include a rotary dial configuration and a writing zone configuration. The portable electronic device may also include an accelerometer, in which case the first dial pad configuration may also include a configuration that requires a user to wave the portable electronic device in the air as if to write a digit.

An additional embodiment includes a method of dialing a telephone number using a portable electronic device. The method includes selecting a first dial pad configuration for dialing telephone numbers using the portable electronic device. The first dial pad configuration is selected from more than one configuration embedded in a memory of the portable electronic device. In the case where the first dial pad configuration is a rotary dial pad configuration, a touch screen display is used. A touch screen display can also be used in the case where the first dial pad configuration is a writing zone and wherein a finger or a stylus is used to write the desired digits on the touch screen display. The display is optionally a capacitive touch screen display. An accelerometer is used when the first dial pad configuration requires the user of the portable electronic device to wave the device in the air as if to write the desired digits.

A system for using hardware of a portable electronic device to dial a telephone number is also described. The system includes a portable electronic device that includes a touch screen display, a processor, a memory and an accelerometer. The display is optionally a capacitive touch screen display. The system also includes instructions stored in the memory and acted upon by the processor to render on the touch screen display one of multiple dial pad configurations that utilizes either the touch screen display or the accelerometer in order to dial a phone number. The instructions might direct the processor to render on the touch screen display a rotary dial pad and to dial digits selected by a user using the rotary dial pad. Alternatively, the instructions may direct the processor to dial digits written using a finger or a stylus on the touch pad display. The instructions may also direct the processor to dial digits written by the portable electronic device being waved in the air in the shapes of the desired digits.

A further embodiment is a computer medium that comprises a software module to perform a method of dialing a telephone number using a portable electronic device. The medium includes instructions for selecting a first dial pad configuration for dialing telephone numbers using the portable electronic device. The first dial pad configuration is selected from more than one configuration embedded in a memory of the portable electronic device. In the case where the first dial pad configuration is a rotary dial pad configuration, a touch screen display is used. A touch screen display is also used in the case where the first dial pad configuration is a writing zone and wherein a finger or a stylus is used to write the desired digits on the touch screen display. The display is optionally a capacitive touch screen display. An accelerometer is used when the first dial pad configuration requires the user of the portable electronic device to wave the device in the air as if to write the desired digits.

Yet another embodiment includes a method of dialing a telephone number using a portable electronic device using a touch screen display. The display is optionally a capacitive touch screen display. The method includes selecting a first dial pad configuration for dialing telephone numbers using the portable electronic device. The first dial pad configuration is selected from more than one configuration embedded in a memory of the portable electronic device. The first dial pad configuration may either be a rotary dial pad configuration or a writing zone and wherein a finger or a stylus is used to write the desired digits on the touch screen display.

A further embodiment includes a method of dialing a telephone number using a portable electronic device using an accelerometer. The method includes waving the device in the air in motions that correspond to digits to be dialed by the portable electronic device.

Other examples, embodiments and applications related to the above description but not heretofore explained in detail are nevertheless considered pertinent and are to be considered within the scope of the following claims.

What is claimed as new and desired to be protected by Letters Patent of the United States is:

1. A portable electronic device comprising:
a display;
a communication system that allows the portable electronic device to send and receive wireless communications; and
a first embedded dial pad configuration selected from more than one dial pad configuration stored in a memory of the portable electronic device, the first dial pad configuration enabling a user of the portable electronic device to dial and call a telephone number using the display and the communication system.

2. The device of claim 1, wherein the display is a capacitive touch screen display.

3. The device of claim 2, wherein the first dial pad configuration is a virtual rotary dial pad on the display.

4. The device of claim 2, wherein the first dial pad configuration is a writing zone on the display, and the telephone number is input by interpreting symbols written in the writing zone.

5. The device of claim 4, wherein the symbols are digits.

6. The device of claim 1, further comprising an accelerometer.

7. The device of claim 6, wherein the first dial pad configuration requires that the device be waved in the shape of digits to be dialed.

8. The device of claim 6, wherein the first dial pad configuration requires that the device be waved in motions that the device associates with digits to be dialed.

9. A method of dialing a telephone number using a portable electronic device, the method comprising:
selecting a first dial pad configuration for dialing telephone numbers using the portable electronic device, the first dial pad configuration being selected from more than one configuration embedded in a memory of the portable electronic device.

10. The method of claim 9, wherein the selected first dial pad configuration is a rotary dial pad configuration.

11. The method of claim 10, further comprising using a capacitive touch screen display to display the virtual rotary dial pad and to input a dialed telephone number based on movements of the virtual rotary dial pad.

12. The method of claim 11, wherein inputting a dialed telephone number comprises determining that a desired digit on the rotary dial pad has been dragged in a predetermined direction to a stopping point on the pad.

13. The method of claim 9, wherein the selected first dial pad configuration is a writing zone on a capacitive touch screen display.

14. The method of claim 13, wherein dialing a telephone number comprises determining that a desired digit was written on the capacitive touch screen display.

15. The method of claim 9, wherein the selected first dial pad configuration requires the portable electronic device to be moved in a manner corresponding to a digit.

16. The method of claim 15, further comprising using an accelerometer to determine motion of the portable electronic device.

17. A system for using hardware of a portable electronic device to dial a telephone number, the system comprising:
a portable electronic device that includes a capacitive touch screen display, a processor, a memory and an accelerometer; and
instructions stored in the memory and acted upon by the processor to render on the capacitive touch screen display one of multiple embedded dial pad configurations that utilize either the capacitive touch screen display or the accelerometer to dial a phone number.

18. The system of claim 17, wherein the instructions direct the processor to render a rotary dial pad on the capacitive touch screen display and to input and dial digits using the rotary dial pad.

19. The system of claim 17, wherein the instructions direct the processor to input and dial digits written on the capacitive touch screen display.

20. The system of claim 17, wherein the instructions direct the processor to input and dial digits based on movements of the portable electronic device that correspond to the digits to be dialed.
